(19) United States
(12) Patent Application Publication
(10) Pub. No.: US 2003/0021728 A1
(43) Pub. Date: Jan. 30, 2003

(54) Method of and apparatus for object-oriented real-time mechanical control of automated chemistry instruments

(76) Inventors: Richard R. Sharpe JR., Lakeville, MN (US); Jerry M. Weinzierl, Bloomington, MN (US); Lyndon A. Walker, Minneapolis, MN (US); John G. Hetzler, Minnetonka, MN (US); Thomas W. Roscoe, Prior Lake, MN (US); Rick A. Marshall, Shorwood, MN (US)

Correspondence Address: BECKMAN COULTER INC, 4300 NORTH HARBOR BOULEVARD, P O BOX 3100, FULLERTON, CA, 928343100

(21) Appl. No.: 09/915,865

(22) Filed: Jul. 26, 2001

(51) Int. Cl. G01N 35/00

(52) U.S. Cl. 422/67; 435/286.1; 435/287.3; 436/43; 436/50; 422/63; 422/116

(57) ABSTRACT

A method of and system for object-oriented real-time mechanical control of automated immunochemistry instruments. The mechanical control method and system has an object-oriented attribute which incorporates and implements one or more of the following characteristics: encapsulation of functionality, information hiding, abstraction, concept of nouns and/or verbs or properties and/or methods, inheritance, specialization, and generalization. The mechanical control method and system has a real-time attribute which satisfies the requirement that certain actions of one or more units of the automated immunochemistry instrument must occur at a specific time in order for the instrument to function correctly, wherein the control system responds to inputs and other stimuli and causes various units of the instrument to respond appropriately in a timely manner.

### BACKGROUND OF THE INVENTION

1. Area of the Art

The present invention relates generally to automated chemistry instruments and methodologies, and more particularly to methods and systems for control of the operations of automated chemistry instruments.

2. Description of the Prior Art

Automated chemistry instruments, particularly automated immunochemistry instruments, are widely used in clinical chemistry sampling and analyzing applications for performing various assays. Such automated immunochemistry instruments often incorporate a mechanical control system for control of the operations of the various units of the automated immunochemistry instrument.

The following references are found to be pertinent to the field of the present invention:

U.S. Pat. No. 6,096,561, issued to Tayi, et al. on Aug. 1, 2000 (hereinafter, “the '561 patent”), disclosed a method for modeling an assay for execution by instrumentation software used on a continuous analytical system for simultaneously performing at least two assays using certain reagents for a plurality of liquid samples. The basic steps of the method include identifying activities to be performed to accomplish the assay and the sequence of the activities for each assay, identifying events to be accomplished for each activity and the time duration of each activity, identifying at least one incubation period between two activities, and scheduling the incubation period and the activities associated with each of the assays according to a predetermined protocol.

U.S. Pat. No. 5,968,731, issued to Layne, et al. on Oct. 19, 1999 (hereinafter, “the '731 patent”), disclosed an automated apparatus for treating a biological specimen with reagents for infectivity assays to manifest an observable test result. The apparatus includes an automated inoculation instrument module for exposing the specimen to a viral assay, an automated specimen preparation instrument module for applying the treated specimen to a surface so adapted to permit detecting the observable result, for applying indicator cells, and for applying liquid reagents, an automated support module for transporting the biological specimen between the automated inoculation instrument module and the automated specimen preparation instrument module including means for effecting multiple assays on the same specimen, at least two of which assays are an infectivity assay, a cytotoxicity assay, or a biochemical assay, and means for controlling at least some of the modules by a remote client, the remote client communicating with the modules through an Internet link to control the performance of multiple assays on the same specimen.

U.S. Pat. No. 5,925,514, issued to Layne, et al. on Jul. 20, 1999 (hereinafter, “the '514 patent”), disclosed an apparatus for performing integrated testing of a specimen potentially infected with a retrovirus. The apparatus includes means for treating the specimen to manifest an observable result, the observable result being the stereotype of the virus as determined by reactivity with a panel of immunoglobulins, the panel employing at least two different immunoglobulins to establish the stereotype of the virus, and means for controlling the means for treating the specimen in order to perform automated testing of the specimen of a type selected from the group consisting of immunological, virological, and cellular testing, the means for controlling the means for treating the specimen being subject to commands of a remote client so that the remote client can control the operation of the means for treating the specimen to carry out a determination of the reactivity of the specimen with the panel of immunoglobulins by performing at least two immunoassays on the specimen, the remote client communicating with the controlling means through an Internet link.

U.S. Pat. No. 5,646,049, issued to Tayi, et al. on Jul. 8, 1997 (hereinafter, “the '049 patent”), disclosed a method for simultaneously performing at least two assays, said assays comprising a plurality of activities, for a plurality of liquid samples on a continuous analytical system. The basic steps of the method include combining an aliquot of a first liquid sample with at least one reagent in a first reaction container to form a first assay reaction mixture for said first liquid sample, combining an aliquot of a second liquid sample with at least one reagent in a second reaction container to form a second assay reaction mixture for said second liquid sample, incubating said first and said second assay reaction mixtures at least one time, performing activities associated with each assay other than said combining and said incubating on the first and second assay reaction mixtures to complete each assay, said other activities including analyzing the incubated assay reaction mixtures, and scheduling the steps of said combining, said incubating, and said performing activities other than said combining and said incubating associated with each of the assays according to a predetermined protocol. The protocol specifies what activities are to be performed for a given assay, an order in which said activities are to be performed, at least one incubation period between said activities of (a), said at least one incubation period comprising a nominal period of time for the performance of an incubating step between activities of (a) and a specified window of time for varying the duration of the nominal period between activities of (a) to optimize performance, how said activities of (a) are to be performed, and the duration of said activities.

U.S. Pat. No. 5,100,622, issued to Mimura, et al. on Mar. 31, 1992 (hereinafter, “the '622 patent”), disclosed an automatic analyzing apparatus for clinical examination. The apparatus includes sampling means for transferring a sample to be examined to a sampling position and for fractionally injecting the sample into a plurality of reaction vessels, said sample containing at least one measurement item, means for adding a reagent to the reaction vessels holding therein the sample fractionally injected by said sampling means to create a reaction solution in each reaction vessel, means for measuring measurement item absorbency of each reaction solvent at predetermined time intervals, first check means for checking whether an abnormality is present in the absorbency value of each measurement then, second check means for checking whether an abnormality is present on the basis of the rate of change of each said absorbency value measured by said measurement means after the reagent is added to the sample in each said reaction vessel, third check means for computing a correlation between data obtained on the basis of absorbency values of measured items measured by said measurement means, and for checking whether an abnormality is present on the basis of the correlation computation, and means for determining, with respect to said sample in accordance with an abnormal measurement item when it is judged than an abnormality is present in the result of at least one check performed by said first, second and third check means, whether remeasurement is necessary and for selecting, in case of remeasurement, remeasurement conditions selected from the group consisting of remeasurement under the same conditions and remeasurement with a diluted sample as compared with that of the first measurement; said means for determining comprising means for presetting degrees of priority of said first, second and third check means; and means for determining, when abnormalities are sensed in a plurality of check results by at least one of said first, second and third check means, whether remeasurement is necessary and the remeasurement conditions in case of remeasurement, in accordance with the result of an abnormality based upon a check having the highest degree of priority, among all checks that show an abnormality, wherein said priority degree presetting means comprises means for presetting the degree of priority in order of said first check means, said second check means and said third check means.

U.S. Pat. No. 5,316,726, issued to Babson, et al. on May 31, 1994 (hereinafter, “the '726 patent”), disclosed an automated immunoassay analyzer. The analyzer includes: an instrument which includes a single platform loading station for receiving both sample tubes and assay tubes, said sample tubes containing a sample to be assayed and said assay tubes containing a bound biomaterial for selectively binding an analyte of interest in a sample wherein said different assay tubes may contain a bound biomaterial for binding the same or different analytes of interest, means for identifying said sample tubes and said assay tubes and for generating identifying information for each of said sample tubes and said assay tubes wherein each of said sample tubes is identified and related to one or more of said assay tubes and wherein the number of related assay tubes for each sample tube can be the same or different, a pipetting station having a pipetter for transferring a sample from a sample tube to a related assay tube, means for selecting a reagent to be added to said related assay tube for performing a particular assay in said related assay tube and for generating selection information corresponding to the selection of a reagent, an incubating station for incubating assay tubes containing sample and reagent, a washing station for washing said bound biomaterial in said assay tube after said assay tubes have been incubated at said incubating station, a detection station for detecting a quantity of analyte bound to said biomaterial in said assay tubes after said assay tubes have been washed at said washing station, said detection station producing a signal proportional to the concentration of analyte for each assay tube, and an assay tube transport pathway connecting said loading station, said pipetting station, said incubating station, said washing station and said detection station, whereby said sample tubes and said assay tubes are separately transported from said loading station to said pipetting station, then said assay tubes are transported to said incubation station, then to said washing station and finally to said detection station. The analyzer also includes means connected to said instrument for monitoring said identifying information obtained from said means for identifying said sample tubes and said assay tubes, said selection information from said means for selecting said reagent, said signal proportional to the concentration of analyte from said detection station and a progression of said assay tubes in said assay tube transport pathway, control means for automatic controlling of various components of the analyzer in a coordinated manner, a display connected for said means for monitoring, means for displaying a pictorial representation of said assay tube transport pathway and said means for selecting a reagent on said display, means for presenting said identifying information in a pictorial format on said pictorial representation related to said progression of assay tubes in said assay tube transport pathway where the position of said assay tubes in said assay tube transport pathway and the assay being performed in each assay tube can be determined, means for presenting said selection information on a pictorial format on said pictorial representation where the reagents selected can be determined; and means for presenting said concentration information for said signal proportional to the quantity of analyte on said display which allows the concentration of an analyte in a particular sample to be determined.

U.S. Pat. No. 4,669,878, issued to Tauster, et al. on Jun. 2, 1987 (hereinafter, “the '878 patent”), disclosed an apparatus for determining the concentration of a substance of interest in each of a plurality of test solutions. The apparatus includes means for supporting a plurality of test solutions to be examined, means for passing light through said plurality of test solutions, means for detecting said light after being passed through said plurality of test solutions and for generating signals representative of the light-transmittance value of each of said plurality of test solutions, and means for analyzing said signals for providing a measure of the concentration of the substance of interest in each of said plurality of test solutions. Said means for passing light through said plurality of test solutions includes means for generating a plurality of beams of substantially monochromatic light of different wavelengths from a substantially continuous range of available wavelengths, and means for directing said plurality of plurality of substantially monochromatic light beams of different wavelengths to different ones of said plurality of test solutions, said beam-directing means comprising a plurality of optical pathways for directing said plurality of substantially monochromatic light beams to said plurality of test solutions, and optical multiplexer means for directing each of said plurality of substantially monochromatic light beams of different wavelengths to a selected one of said plurality of optical pathways for directing each of the substantially monochromatic light beams of different wavelengths to a selected one of said plurality of test solutions.

While various control arrangements and procedures for automated immunochemistry instruments have been developed, as disclosed in the above references, these control arrangements and procedures are limited by the features and functions of the prior art automated chemistry instruments. Moreover, these prior art control arrangements and procedures were either not object-oriented or not performing in real-time, or did not provide control protocols that combine both object-oriented features and real-time features. Therefore, it is desirous to create and develop a mechanical control system and protocol that combines both object-oriented features and real-time features to control the operations of the various units of an automated immunochemistry instrument.

### SUMMARY OF THE INVENTION

The present invention is directed to a novel method of and system for object-oriented real-time mechanical control of an automated immunochemistry instrument.

It is an object of the present invention to provide a new method of and system for mechanical control of an automated chemistry instrument that is object-oriented. A mechanical control system and method is “object-oriented” when it incorporates and implements one or more of the following characteristics:

Encapsulation of functionality, which refers to the software practice of creating a set of software with well defined behavior, responsibilities and interfaces;

Information hiding, which refers to the software practice of keeping details of objects “internal” to the object;

Abstraction, which refers to the software practice of using base classes to encode similar behavior;

Concept of nouns/verbs or properties/method, which refers to the software practice of interacting with objects in two ways: first, the objects have properties (these are the “nouns”); and second, objects have methods (these are the “verbs”); and

Inheritance, specialization and generalization, which refer to the software practice of encoding features of an object in layers of software that cause more and more specific definition of the object. In the present invention, various mechanical assemblies are associated with software subsystems. It starts in software with a subsystem base class and all subsystems inherit from the base class. Since many assemblies are X and Z gantry-based, these subsystems are further defined as “subsystem 2 Axis”, which adds the software capabilities of two-dimensional movement.

It is also an object of the present invention to provide a new method of and system for mechanical control of an automated chemistry instrument that is “real-time.”

A mechanical control system and method is “real-time” when some input/controlling actions must occur at correct times for the result to be correct, and/or when it satisfies the requirement that certain actions of one or more units of an instrument must occur at a specific time in order for the instrument to function correctly, where the control system responds to inputs and other stimuli and causes various units of the instrument to respond appropriately in a timely manner.

It is another object of the present invention to provide a new method and system for mechanical control of an automated chemistry instrument that combines both the object-oriented and real-time features to control the operation of the subsystems of the automated immunoassay instrument, so that the analytical process can be carried out reliably and repeatedly.

Described generally, the new method of and system for object-oriented real-time mechanical control of the present invention is for controlling the operations and functions of an automated chemistry instrument.

Such an arrangement has been found to provide a number of advantages. As explained in greater detail below, the new method of and system for object-oriented real-time mechanical control of automated chemistry instruments combines both the object-oriented features and the real-time features to control the function and operation of the various units of an automated immunoassay instrument, so that the analytical process can be performed with desired reliability and consistency.

The control system and method of the present invention may be used in connection with an automated immunochemistry analyzer, and other chemical analyzers, such as, but not limited to, chemistry and hematology diagnostic instrumentation.

The invention is defined in its fullest scope in the appended claims and is described below in its preferred embodiments.

### DESCRIPTION OF THE FIGURES

The above-mentioned and other features of this invention and the manner of obtaining them will become more apparent, and will be best understood by reference to the following description, taken in conjunction with the accompanying drawings. These drawings depict only a typical embodiment of the invention and do not therefore limit its scope. They serve to add specificity and detail, in which:

FIG. 1 is an illustrative block diagram showing the basic structural and functional modules of an automated immunochemistry instrument having various subsystems that are controlled by the method of and system for object-oriented real-time mechanical control of the present invention;

FIG. 2 is an illustration of an exemplary instrument timeline, showing a gripper moving in coordination with a shuttle and a wheel.

### DETAILED DESCRIPTION OF THE INVENTION

The present invention is directed to a novel and new method of and system for object-oriented real-time mechanical control of an automated immunochemistry instrument.

According to the present invention, the automated immunochemistry instrument is formed of two basic parts: a control system and an analytical unit (AU). In one embodiment of the present invention, the control system is a console which is a Microsoft® Windows™ NT based system running on a Pentium™ based workstation style computer that performs monitoring and control over the AU, and interacts with the users, the Laboratory Information System (LIS), and its database, where all interaction with the AU is socket based Ethernet messages.

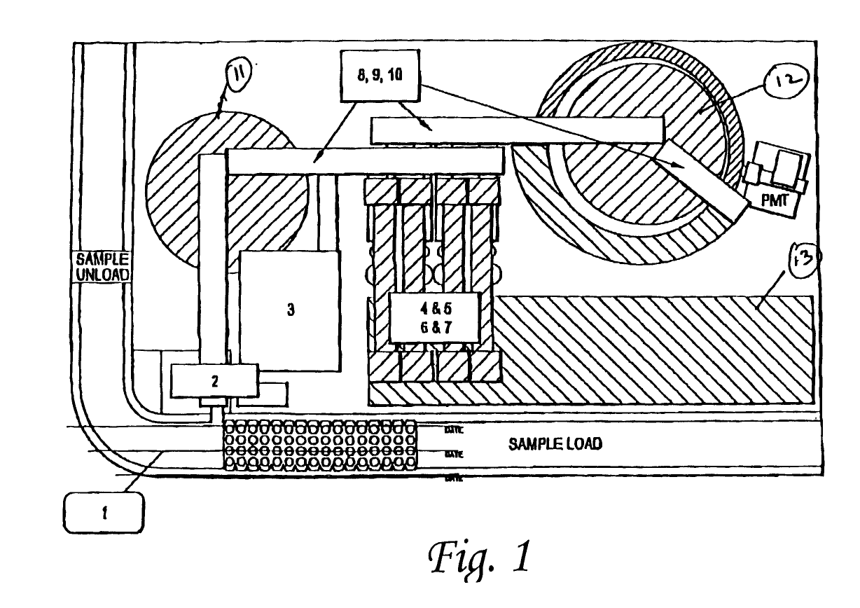

Referring to FIG. 1, there is shown an illustrative block diagram demonstrating the basic structural and functional subsystems of the AU. A detailed description of some of the functions and operations of the AU is provided in the Assignee's co-pending patent application for “Method and System for Automated Immunochemistry Analysis,” Ser. No. 09/815,088, and is incorporated herein by reference.

As shown in FIG. 1, the basic structural and functional subsystems of the AU include a sample presentation unit 1, a main sample aliquoting station 2, a bulk vessel feeder 3, first dual reagent pipetting stations 4 and 5, second dual reagent pipetting stations 6 and 7, a first Pick and Place (PnP) gripper 8, a second PnP gripper 9, a third PnP gripper 10, a sample aliquot storage unit 11, an incubator/wash/read station 12, and a reagent storage unit 13.

The sample presentation unit 1 is used to transport the entire required test samples to and from the main sample aliquoting station 2. A detailed description of the configurations and functions of the sample presentation unit 1 is provided in the Assignee's co-pending patent application for “Sample Presentation Unit,” Ser. No. 09/848,450, and is incorporated herein by reference.

The main sample aliquoting station 2 is used to aspirate sample aliquots out of the sample tubes and dispense them into sample vessels supplied by the bulk vessel feeder 3. A detailed description of the configurations and functions of the sample aliquot storage unit 11 is provided in the Assignee's co-pending patent application for “Method and System for Sample Aliquot Storage” and is incorporated herein by reference.

The bulk vessel feeder 3 provides empty vessels to the automated immunochemistry instrument for containing samples and reagents. A detailed description of the configurations and functions of the bulk vessel feeder 3 is provided in the Assignee's co-pending patent application for “Bulk Vessel Feeder,” Ser. No. 09/777,750, and is incorporated herein by reference.

The four reagent pipetting stations 4, 5, 6, and 7 are used to mix sample aliquots with reagents for subsequent assay. The four reagent pipetting stations 4, 5, 6, and 7 are arranged as two dual reagent pipetting stations and are independent to each other, each having its own fluid pumps and valves, wash towers, reaction vessel carriages, and pipettor. The individual structures and functions of each of these reagent pipetting stations 4, 5, 6, and 7 conform to existing arrangements used in the Access Instruments (Beckman Coulter, Inc., California), which are known to those of ordinary skill in the art, and therefore will not be described in detail here.

The three vessel PnP (PnP) grippers 8, 9, and 10 are used to transport sample and reaction vessels among the various modules of the automated immunochemistry instrument. The first PnP gripper 8 is used to transport sample vessels among the bulk vessel feeder 3, the sample aliquot storage unit 11, and the reagent pipetting stations 4, 5, 6, and 7. The second PnP gripper 9 is used to transport reaction vessels between the reagent pipetting stations 4, 5, 6, and 7 and the incubator of the incubator/wash/read station 12. The third PnP gripper 10 is used to transport reaction vessels between the incubator/wash wheel of the incubator/wash/read station 12. A detailed description of the configurations and functions of the vessel PnP grippers 8, 9, and 10 is provided in the Assignee's co-pending patent application for “Method and System for Picking and Placing Vessels,” Ser. No. 09/7771,471, and is incorporated herein by reference.

The sample aliquot storage unit 11 is used for storing the sample aliquots contained in the sample vessels at a low temperature for a certain period of time, e.g., up to three (3) hours, so that the samples may be used for reflex testing. When a test is requested on a patient sample, the test outcome may drive a request for additional testing. This automatic request for additional tests is reflex testing. The sample aliquot storage unit 11 may utilize a sample storage wheel for holding sample vessels.

The AU may also include various carriages or shuttles which move vessels to and from the various PnP's and pipettors and the reagent supply unit.

The object-oriented real-time control system is an important part of the automated immunochemistry instrument. The subsystems of the AU as shown in FIG. 1 take and store fluid samples from patients, add specified reagents in specified amounts at specified times, perform other processing including incubation, and read the resulting raw result via luminometer and generate a final test result, etc. The other subsystems of the AU aliquot samples, store samples, store and provide empty vessels, add reagents to vessels, wash vessels, control temperatures and pressures, control vacuum supply, control fluid levels and keep track of capacities and limitations, etc. There are also many “passenger” objects that are passed between the subsystems and acted upon by the various subsystems of the AU. The object-oriented real-time mechanical control system and method of the present invention control the functions and operations of these subsystems and makes the analytical process possible, reliable and repeatable.

The phrase “real-time” refers to the requirement that certain actions must occur at a specific time in order for the machine to function correctly. The mechanical control system responds to inputs and other stimuli and causes the various subsystems of the immunochemistry instrument to respond appropriately, in a timely manner. Examples of such inputs and stimuli may include pressure profiles, temperatures, sensor signals, level signals, rotational position parameter, Cartesian position parameters, barcodes, etc.

The phrase “object-oriented” refers to a design and implementation that incorporates one or more of the following characteristics: encapsulation of functionality, information hiding, abstraction, concept of nouns/verbs or properties/methods, inheritance, specialization and generalization.

As a style for software development that yields several benefits, object-oriented software programs are easily coded, reusable, adaptable, maintainable, and extensible, documentable and teachable, and modular and piecewise/component testable.

A. The Software Architecture of the Object-Oriented Real-Time Mechanical Control Method of the Present Invention Includes the Concept of “Layers”, “Objects” and “Classes”

1. Layers

(1) Driver Layer

Custom device drivers are necessary to support the hardware subsystems. For example, device drivers are required for nonvolatile memory, analog input, luminometer, mixer speed control, wheel encoders, etc. Additionally, drivers are required to support message protocols over serial lines for the motion control cards (MCC), the radio frequency (RF) level sense card, and the reagent supply encoders, etc.

(2) Device Layer

The next layer of software, the device objects, has the only access to the device drivers. Device objects maintain their own states such as position, ownership of the hardware, running/stopped, etc. These objects will use overlapped input/output (I/O) to the device drivers. In the AU, devices are controlled via the subsystem object to which they belong.

(3) Subsystem Layer

This level of software corresponds approximately to the physical subsystems of the AU described above. Software program classes are used to generalize the software. For example, a class “Pipettor” may be used as a base class, to be inherited by “Sample Pipettor”, and “Reagent Pipettor” classes/objects. Similarly, the “Sample Wheel” and “Incubate Wheel” classes/objects may share a common base class “Wheel”. The member functions of these classes provide all the subsystem operations necessary for mechanical control.

Subsystem objects are responsible for performing coordinated movements, such as aspirating while lowering into tubes. Subsystem objects will record precisely the times and durations of all their actions and device responses. Moving subsystems will frequently “home” themselves, or verify position using the home, to prevent cumulative error. Subsystem objects continuously validate their behavior in system specific ways, such as checking for stepper slipping while homing. Subsystems also use digital and analog sensors to verify correct operation, such as pressure measurements of aspiration and wash cycles in pipettors.

The subsystems also provide error handling for themselves, but do not execute it automatically. They report specific errors to the sequencer, and are told to recover by a sequencer of the control system which will be described later. Subsystems record and may display diagnostic information about their performance.

(4) Sequencer Layer

The object-oriented real-time mechanical control system of the present invention includes a sequencer. The primary function of the sequencer of the control system is to tell the subsystems what to do and when. These actions are defined in the timeline, along with their expected duration. The sequencer is also responsible for taking instructions from the scheduler, and making sure the subsystems execute the actions on time. The set of all actions to be performed is called the “Sequence Table”. This table is a private member of the sequencer. The sequencer provides functions that allow the scheduler to add and remove sets of actions to this table using a transaction pattern.

When subsystems detect errors, they are reported to the sequencer along with a bit vector that determines the error handling operations. The sequencer uses the bit vector to control the subsystems during error handling. Refer to the error handling section for more information.

The layers of software from the driver layer to the sequencer encompass the real-time behavior of the control system.

(5) Scheduling Layer

The object-oriented real-time mechanical control system of the present invention also includes a scheduler. The scheduler is responsible for planning actions of the AU in the near future. It maintains the current and future state of AU resource usage, and therefore “knows” when various operations would interfere with each other. It prevents such operations from happening at the same time by planning around the collision. It utilizes “Timeline Tables” which describe how long each internal subsystem movement or action will take.

The scheduler takes test requests, data and the instrument timeline, and uses them to generate the subsystem-time-and-operation data used by the sequence engine. It also determines the route of vessels through the AU during tests via the allocation of resources.

Oftentimes the AU responses to user actions, which must be synchronized with the timeline. The scheduler takes notifications from subsystems of these user actions, and determines where the responses to them can fit into the timeline. The scheduler is also responsible for parking subsystems when they are known to be idle, and for periodic wakeup behavior.

(6) Control Layer

The primary functions of the Control layer include:

Startup coordination and information exchange

Logging of results and errors

Execution and Results of Diagnostics

Execution of Console commands and returning responses

Operations are sent from the Console and executed by the AU, with a result message on completion. Events of various types are generated by the AU and sent to the Console.

The Control layer is responsible for maintaining the reliability of communications and the state of operations that are in process.

2. Objects

(1) Passenger Objects

Passengers are owned by the various subsystems, and travel through the AU. Each passenger knows the location, subsystem and passenger number, and where it is located within the AU. They correspond with physical objects. Each subsystem maintains a list of its passengers. Passengers are passed among subsystems as the physical objects are moved between physical subsystems. Passengers also contain references to each other, and maintain a state text property that is modified by the current owner of the object to indicate what is happening to the passenger. Some passenger properties may be nonvolatile, and restored at AU startup.

(2) Route

This object contains all the locations that the vessel will occupy during a test. It is created by the scheduler and used by the subsystems. The route object contains the path that a vessel follows through the AU during a test. The route is a member of the Reaction Vessel (RV) object. It contains all the locations within subsystems that the vessel will inhabit. These include:

Sample Wheel slot

Reagent Pipettor and Shuttle number

Incubation Wheel slot

Wash Wheel slot

The route is determined by the scheduler and is sent by the sequencer to the subsystems along with the operation to be performed. As an example, one of the operations of the sample wheel is “rotate sample to the sample PnP position for loading”. The sample wheel must use the associated route object to know which slot the sample occupies.

(3) Recipe

This object contains all the information necessary for the test. It is created by the scheduler, and used by the subsystems during operations. The recipe is a member of the RV object. Its attributes include:

Assay identifier

Aspiration and dispensing heights and volumes

Ultrasonics mixing information

Pipettor behavior

Incubation times

The recipe is determined by the assay developer for each assay and is sent by the sequencer to the subsystems in the RV object along with the operation to be performed. For example, the reagent pipettors and wash wheel must use the associated recipe object to know how to operate the pipettor pumps and substrate pump.

(4) Chronicle

The chronicle object is the set of diagnostic information and timestamps taken as a sample passes through the AU during a test. The chronicle is a member of the RV object.

For example, when a sample is initially loaded into the sample wheel, the initial timestamp is saved. When the sample is pipetted into a vessel, a new chronicle is created, given the initial timestamp, and associated with the sample under test. The chronicle is used to keep all interesting information generated as the vessel traverses the AU. The time and values from the luminometer are the last entries saved by the chronicle object. Some chronicle information will be reported to the Console at test completion.

The sequencer sends the chronicle to the subsystem along with the operation to be performed to the subsystem objects. A member function of the chronicle may cause a textual detailed report or a summary of the vessel's journey through the AU.

(5) Action

Actions are associated with a vessel, holding a sample under test. The sequencer maintains an array of actions to be performed. An action describes a subsystem operation to be performed at a time. When the scheduler sends a schedule time and a set of actions to the sequencer, the times in the action are relative to the schedule time parameter. When those actions are added to the sequence table, the relative times are converted to absolute.

3. Subsystem Base Classes

The subsystem base classes are primarily used to provide group behaviors of device objects. They generally reflect physical subsystems within the AU. As an example, a reagent pipettor subsystem object contains a collection of motor objects for its X and Z motions and a pump motor. Additionally, there are various associated sensors, such as fluid pressure and level sense that it needs perform its job.

Subsystem base classes are the layer of software between the device objects and the sequencer. Subsystems also allow the diagnostic and maintenance applications to operate physical subsystems, rather than just individual devices. An alignment application, as an example, can operate on a pipettor rather than a motor. An entire pipettor may be moved to a safe position and state as one operation. The user of the subsystem object generally doesn't need to know about the its device objects. Each device in the AU belongs to exactly one subsystem.

(1) Base Class Behaviors

Subsystems are accessible via the AU object's “subsystem” property. Subsystems may also support an additional specific interface, available through the “specific” property. This allows the software group to aid the mechanical and electrical groups during the project development.

The subsystem base class is used to hide much of the complexity of thread creation and synchronization from the specific subsystems. Additionally, nearly all of the mechanisms for supporting the sequencer's demands are in the base class. The base class provides a queue of sequencer commands and parameters, a thread for executing commands, locking and handshaking, and command execution statistics.

The virtual members of the subsystem base class are used to define standard patterns of behavior for subsystems. For example, subsystems must know how to home, move to initial position, park, and wake, and some must implement a pair of “handle errors” and “repair errors” functions that are used in a standard way to interact with the sequencer to handle and recover from errors.

Subsystems handle a passenger array, containing passengers that are currently “in” the subsystem. The entries in this array correspond to physical places. The passenger handling and custody transfer functions of the base class ensure that error checking is handled consistently among all subsystems. For example, no passengers are allowed to occupy the same slot, and when a passenger is transferred, both the source and destination are sanity checked. The base class provides services to determine when subsystems may safely interact.

In addition, the initialization of alignment and other persistent data is performed by the base class.

(2) Derived Class Responsibilities

Class responsibilities are derived from their common base class.

For example, each subsystem must instantiate its devices and provide access to their interfaces via the “devices” property. Each subsystem must also provide member functions to perform all the behaviors required to all the required operations of the subsystem. These functions will be used to control the subsystem.

Interactions between subsystems must be verified. Each subsystem should verify that a interacting subsystem is in the correct position before performing a physical passenger transfer. For timing jitter tolerance, subsystems should allow some delay when the interacting system is not ready.

Subsystems are also responsible for process monitoring. All motion that crosses a home flag must be verified. All movement checking sensors must be verified. Pressure and temperatures must be verified. The subsystems are responsible for recording successes, failures and other measurements in the RV chronicle. As subsystems act on passengers, such as addition of volume, they must adjust the properties of the passengers appropriately.

Each subsystem is further responsible for notifying the Console regarding user actions detected via sensor, error events, other events as required.

4. Subsystem Based Non-Specific Virtual Classes

Many of the AU subsystems can be grouped into one-dimensional and two-dimensional subsystems. The following virtual classes are used to facilitate code reuse and promote consistency.

(1) One Axis Subsystems

One axis subsystems contain at least a single “motor”. The configuration for the “motor” is loaded by the “Subsystem 1-Axis” base class. Absolute and relative movement convenience functions are provided.

For wheel based subsystems, a rotate-to-angle function is provided, support for encoders to verify position is also provided, and geometry of the passenger positions is further supported. For shuttle based subsystems, advance and retract (move one slot) moves are provided.

(2) Two Axis Subsystems

Two axis subsystems contain at least two “motors”, which may be named as the “X-motor” and the “Z-motor”. The configuration for the “motors” is loaded by the “Subsystem 2-Axis” base class. Absolute and relative two-dimensional movement convenience functions are provided. Such 2-axis subsystems may include:

Pipettor based subsystems

PnP Subsystems

5. Subsystem Based Specific Classes

There are also subsystem based specific classes which are used to instantiate specific subsystem objects. Such classes include:

Sample PnP

Incubate PnP

Wash PnP

Sample Wheel

Wash Wheel

Incubation Wheel

Reagent Shuttles

RV Supply Shuttle

Sample Pipettor

Reagent Pipettor

Sample Wash

Reagent Wash

RV Supply

Reagent Supply

Sample Presentation Unit (SPU)

Lumi-Control

Temperature Control

Fluid Level Control

Pressure Control

Vacuum Control

Liquid Waste Control

Solid Waste Control

LED Panel

B. The Sequencer and Scheduler of the Object-Oriented Real-Time Mechanical Control System of the Present Invention

1. The Sequencer

(1) The sequencer is responsible for starting time critical operations in the AU at the correct time. The sequencer operates on data supplied by the scheduler, and drives the subsystem objects. During error handling, the sequencer controls the AU in order to recover from the errors.

The sequencer maintains an array of absolute time actions, called the “Sequence Table”. The sequencer “wraps” around this array, i.e., no access to the Table is allowed or provided, except through the sequence object interface. Methods are provided to add and remove actions from the table. These methods are transaction based, using an open-add-add-commit/cancel paradigm.

The sequencer uses the multimedia timer to sleep until it is time to execute the next action. It then removes the action from the sequence table and sends it to the appropriate subsystem worker thread and mailbox.

(2) Additionally, the sequencer is responsible for error recovery. The sequencer object provides an interface for subsystems to perform a callback error report. The sequencer will then perform the actions to record, report and if possible, correct the error. The sequencer provides a “toolbox” of error handling functions; the subsystem with the error tells the sequencer which tools are necessary to recover from the problem.

(3) Furthermore, the sequencer is responsible for:

Hiding threading and synchronization details from the subsystem objects and scheduler;

Hiding details of device coordination;

Verifying that the scheduler requests are realizable (not scheduled into the past);

Maintaining the association of actions to RV's, samples, and packs under test;

Performing multi-thread coordination/locking to protect the integrity of its data;

Reporting status, time until idle, which tests are committed, number of tests underway, etc.

2. The Scheduler

(1) The scheduler is responsible for determining the times when sets of actions must be executed. Conflicts over access to hardware and other resources are resolved. User requests are coordinated with timeline operations.

There are two principal data structures maintained by the scheduler. The test request queue is a priority ordered list of RV's. This list is modified whenever the Console sends test request messages to the AU. Whenever it is possible to run a new test, the scheduler searches the list, in priority order, for a runnable test. When found, the test route, recipe, and action sequence is determined. The route and recipe are written to the RV object, and the action list is sent to the sequencer, and associated with the RV identification.

The other important data structure is the “Resource Usage Table”. For every important resource the scheduler maintains a list of reservation times that indicate when the resource is busy. As an example, Incubate Wheel slot #1 is a resource that is marked as busy whenever an RV is planned to occupy that position. Each test request is converted into a timed list of resource reservations. Start times and order of testing are adjusted for no collisions of resource usage and maximal use of resources. This results in the maximum throughput.

(2) Resources are used to plan the RV's route through the AU and to coordinate subsystem actions. Such scheduled actions may include:

Advancing the Wash Wheel

Either tossing an old Sample Vessel (SV), or loading an empty SV to the Sample Wheel

Moving a reagent pack either to or from the load tray, or tossing an empty pack

Scheduling utility assays when necessary

Scheduling either a probe wash or a test

Tossing an old RV from the Incubate Wheel, or a two-step delay move

Scheduling the aliquot of a sample into an empty sample vessel (SV) in the Sample Wheel

Advancing the SPU

Dropping empty vessels into the RV Supply Shuttle

Telling the subsystems to check their temperatures and pressures

Advancing the Liquid Waste, Solid Waste, Vacuum, and wash buffer supply subsystems

Verifying that the AU is capable of running a test (checking hardware)

(3) The scheduler may also be responsible for:

Inserting a stat test request, based on a notification from the SPU

Scheduling a maintenance action, based on a notification from the SPU

Estimating walkaway time based on current supplies

Canceling a scheduled, waiting test

Canceling all scheduled, waiting tests

Canceling all tests, even the running ones

(4) Scheduler Resource Tracking

Resources reservations are used to ensure that many tests may run in the AU cooperatively. Resources are strictly a software bookkeeping feature used to resolve conflicts in schedules. Resources are generally positions within subsystems, such as incubation and wash wheel slots. Subsystems themselves may also be resources. Resources tracked by the scheduler may include:

Samples

Reagent Pipettors and Shuttles

Reagent Packs

Incubation Wheel Slots

Wash Wheel Slots

Supplies

PnP usage

A resource usage is the set of Owner, StartTime, and Duration. A usage means that the resource is reserved by the Owner at the StartTime, for the Duration. Each resource is therefore StartTime ordered array of resource usages. This defines all the reservations made on the resource.

As an example, consider the reagent pipettors. Since up to four tests can be run independently at a time, there are four pipettor resources. Each pipettor resource is an array of usages.

Examples of the importance of resource tracking include:

Each sample vessel is one resource, so two tests should not be run on the same sample at the same time.

Each reagent pack is a resource, so two tests that use the same pack should not be run at the same time. Note that packs of the same type and lot number are interchangeable.

Each incubation wheel slot is a resource, so two RVs should not be put into the same slot.

Since the Wash PnP can only place a vessel into one place in the wash wheel, the “Wash In” position has a single resource. This resource prevents two tests of differing incubation times from finishing at the same time and colliding at the “Wash In” position.

Since the Incubate PnP can only pick up one vessel at a time, it has a single resource. This resource prevent multiple two step or piggyback tests of differing incubation times from needing to be picked up at the same time and colliding at the beginning of the second pass.

A test can be run if and only if all resources needed by the test may be reserved at the times that the test requires them. With the exception of supply resources, it is always possible to schedule a test if we look far enough into the future.

Once the scheduler determines that all the resources that a test needs are free when the test needs them, the Route object is constructed based on the resources that are reserved. If all the resources are not available when they are needed, the scheduler tries again, looking farther into the future. After the route is constructed, the actions are sent to the sequencer.

(5) Timeline Data Tables

The following tables are obtained from data files that are loaded by the scheduler at object creation. The data files are derived from the timeline file. Sets of operations are grouped together in the project. Each item name begins with a subsystem. These names are used to generate data tables:

PreTest Table:—This table causes the SV to be moved from the sample wheel to the chosen reagent shuttle and the RV and Dilution Vessel (DV) to be moved from the supply shuttle to the reagent shuttle. The shuttle is then moved to the pipetting position. If necessary, a reagent pack is moved from a home nest to the pipetting position.

Postpipetting Table: This table contains the operations that cause the SV to be returned to its home slot in the sample wheel and the RV to be moved from the reagent shuttle to the incubation wheel. Additionally, if the next assay scheduled for this pipettor doesn't use the same reagent pack, the pack is returned to its home nest.

Wash Table: This table contains the set of operations that pick an RV from incubation, and wash it, in preparation to luminometer read. The washwheel automatically reads the RV when it is in position and saves the resulting value in the RV value.

Two-Step Delay Table: This table is used in piggyback assays. It causes the RV to be brought from the incubation wheel back to the reagent shuttle for additional reagents.

Multi Step Next Pass Table: This table is used only during piggyback, two, and three step assays. It contains the operations that cause the RV to be picked up from the incubate wheel and sent back to a reagent shuttle for additional reagents.

Waste Table: This table contains the set of operations that move an RV from the washwheel and cause it to be thrown away. An RV is also saved as a completed test.

PostTest Table: This table completes the test. Counters for tests are updated; resources are freed; the RV is converted to a result to be reported to the Console.

Background Load Vessel Table: This table contains the operations necessary to move empty vessels from the supply into the sample wheel.

Background Load Sample Table: This table contains the operations necessary to load samples from the SPU into the sample wheel. This table is scheduled when a rack of samples is detected at the SPU entrance.

Background Sample Cleanup Table: Periodically, samples in the sample wheel must be disposed of because they are no longer needed, or they have expired. This table contains the operations necessary to dispose of a sample.

(6) Sequencing the Test

The test request contains a test type identifier that is used to obtain the process data for an assay. This data includes the test type, one step, two step, or piggyback, the reagents to be used and the incubation time(s). Based on a start time of zero, the scheduler uses this data to determine the relative times that the sample vessel must pass through pipetting, incubation and wash/read.

The test sequencer determines a start time and route through the AU, which uses only free resources, and send the set of subsystem actions that implement the test to the sequencer. Once the route has been chosen, the process of sequencing a test must done as a single transaction. As all of the actions are sent to the sequencer, any failure must free the previously sequenced actions and free the resources that were allocated. Unless all the actions can be successfully sequenced, they must all be freed. An assay schedule being sequenced is inactive until the entire assay is sequenced. If, after sequencing, too much time has passed, the sequencer will reject the commit, and rescheduling must occur.

The sequence of actions that determine a single pass test are defined in various sequence tables, including “Pre Test Table”, “Post Pipette”, “Wash In Table”, “Waste Table”, “PostTest Table”, and the pipetting cycle tables.

(7) Test Schedule Optimization

Initially, the test order optimization is exactly the same as that of Access and Access2 (available at Beckman Coulter Inc. Fullerton). The following rules may be applied in determining priority:

Stat test requests have the highest priority

Reflex tests have the second highest priority

Assays with the longest total incubation times are scheduled first;

In the event of a tie (both total incubation times are equal), the priority is:

Two step assays first,

Piggyback assays second, and

One step assays last (as sorted by incubation times).

C. The Mechanical Control Method and System of the Present Invention Combines Both Object-Oriented and Real-Time Attributes

1. Object-Oriented Features

The key features of the object-oriented attribute of the mechanical control method and system of the present invention are as follows:

(1) The Real-Time Features are Hidden in the Subsystem Base Class

Subsystems are provided with control methods via the base class that they all inherit from that hide the complexity and coding required for real-time behaviors. Such real-time behaviors may include multi-threading, access control and synchronization, and communication between threads and processes.

(2) Other Higher Level Responsibilities of the Subsystem Base Class

Such responsibilities may include:

Passenger exchange

“Other” units position verification

List of passengers

Geometry of passengers

Negotiation of geometry

Maintaining non-volatile memory

(3) Concept of the Unit Controller

Since all of the subsystems of the automated immunochemistry instrument share a common base class, the control system can operate the subsystems without knowing the details of their implementation of behavior. The common control system is necessary to guarantee that these multiple units interact correctly and that the instrument as a whole has its integrity. The control system “knows” and causes actions to be performed on specific passenger objects at specific times through the functions of its scheduler and sequencer as described herein.

(4) Concept and Importance of the Passenger Object and Base Class

The idea that the various subsystems perform actions at specific times on passengers is central to the mechanical control method and system of the present invention. Passengers are polymorphic. For an automated immunochemistry instrument, such passengers may include:

Empty vessels

Sample vessels

Reacting vessels

Dilution vessels

Reagent Packs

Samples

Sample tube racks

The object-oriented mechanical control method and system of the present invention “know” the respective types of the passengers, the respective locations of the passengers with the automated immunochemistry instrument and its subsystems, and the respective specific states of the passengers. The subsystems of the automated immunochemistry instrument either operate on, transform, or transfer passengers. For example, in the automated immunochemistry instrument shown in FIG. 1, empty vessels are transformed into sample vessels when a patient sample is added to them. The sample aliquot storage unit exchanges sample vessels with a PnP gripper. The passenger template base class provides facilities for passenger creation, destruction, enumeration and state recovery in nonvolatile memory.

(5) Instrument State Verification

At all times, the various units of the automated immunochemistry instrument know which passengers they own and the control system knows which unit the passengers belong to. This redundancy allows the internal controllers of the units to maintain an estimate of the accuracy of total instrument consistency. In addition, each passenger may be branded with unit action verifications and failures. For example, if a pipetter pump is seen to be in the wrong position after a reagent dispense, the reaction vessel can be marked with a “reagent failure.” Alternatively, when a unit action on a reaction vessel is to be verified, the reaction vessel can be marked with an “action x succeeded at time t.” A completed test that has all necessary successes is expected to be reliable.

2. Real-Time Features

The most important feature of the real-time attribute of the mechanical control method and system of the present invention is its timeliness. A system is considered real-time when the “value” of an action is lost if it does not happen at the correct time. The mechanical control system of the present invention has specification-required accuracy of the timing of actions.

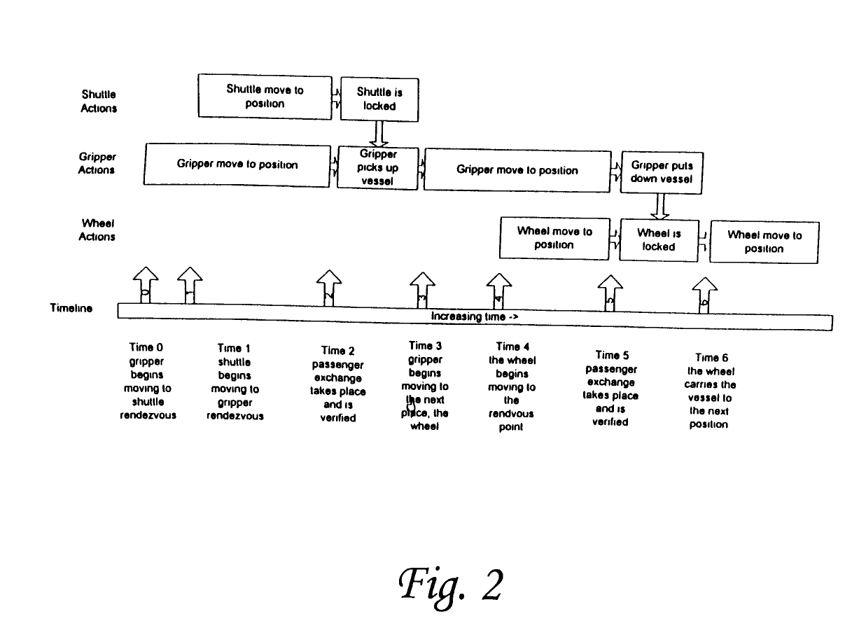

Referring to FIG. 2, there is shown an example of the PnP gripper 8 transferring a vessel from the reagent shuttle to the sample wheel, as the gripper takes the vessel from the shuttle and gives it to the wheel:

At Time “0”: the gripper begins moving to the shuttle rendezvous point;

At Time “1”: the shuttle begins moving to the gripper rendezvous point;

At Time “2”: vessel exchange takes place and is verified;

At Time “3”: the gripper begins moving to the next place (i.e., the wheel);

At Time “4”: the wheel begins moving to the rendezvous point;

At Time “5”: vessel exchange takes place and is verified; and

At Time “6”: the wheel carries the vessel to the next position.

If the various subsystems do not operate at the expected times, they are not in position to do the transfer. The real-time mechanical control system of the present invention allows patient samples and reagents to be moved through the units in an exactly defined and repeatable manner. It is assured that a test result is correct if all the actions of the subsystems are correct and timely.

The method and system of object-oriented real-time mechanical control of the present invention for automated immunochemistry instrument has many novel and unique features and advantages. Most importantly, the present invention mechanical control system combines both the object-oriented features and the real-time features to control the function and operation of the various units of an automated immunoassay instrument, so that the analytical process can be performed with desired reliability and consistency.

The present invention control system may also be used in various instruments with motors, movers, pumps, valves, fluidics, pressure measurements, compressor control, switch monitoring, temperature monitoring and control, luminometer, and other measurements.

The foregoing is meant to illustrate, but not to limit, the scope of the invention. Indeed, those of ordinary skill in the art can readily envision and produce further embodiments, based on the teachings herein, without undue experimentation.

It is to be understood that the form of the system depicted in FIGS. 1 and 2 has been chosen only for the purpose of describing a particular embodiment and function of the invention, and that the arrangement of the invention can be addressed in various ways and incorporated in other types of devices, all of which will be evident to those working in the art.

It is to be understood that the particular arrangement of the present invention may vary, depending on the chemical analyzer instrument it is incorporated or working together with, but that the determination of necessary variation is well within the skill in the art in view of the instant disclosure.

Suitable components that are commercially available would be known to those of ordinary skill in the art in view of this disclosure.

It is further understood that any comparable means of accomplishing this goal is within the scope of this invention.

The present invention may be embodied in other specific forms without departing from its essential characteristics. The described embodiment is to be considered in all respects only as illustrative and not as restrictive. The scope of the invention is, therefore, indicated by the appended claims rather than by the foregoing description. All changes which come within the meaning and range of the equivalence of the claims are to be embraced within their scope.

What is claimed is:

1. An apparatus for automated immunochemistry or chemistry analysis, comprising:
a. an analytical unit having a multiplicity of subsystems for performing immunochemistry or chemistry assays, including:
(i) a sample presentation unit for loading samples;
(ii) a sample aliquoting station unit for aliquoting samples;
(iii) a sample aliquot storage unit for storing sample aliquots;
(iv) a bulk vessel feeder unit for supplying empty vessels used for containing sample aliquots and reagents;
(v) a multiplicity of reagent pipetting station units for pipetting sample aliquots and reagents;
(vi) a reagent storage unit;
(vii) an incubation station unit; and
(viii) a multiplicity of pick-and-place grippers for transporting sample and reagent vessels; and
b. a mechanical control system having both object-orient features and real-time features for control the operations of said multiplicity of subsystems of said analytical unit.

2. The apparatus as defined in claim 1, wherein said mechanical control system comprises a sequencer for starting said operations of said multiplicity of subsystems of said analytical unit at correct times respectively.

3. The apparatus as defined in claim 1, wherein said mechanical control system comprises a scheduler for determining the times when one or more sets of operations of said multiplicity of subsystems of said analytical unit must be executed.

4. The apparatus as defined in claim 1, wherein said object-orient features of said mechanical control system include the feature of hiding the real-time features in the subsystem base class.

5. The apparatus as defined in claim 1, wherein said object-orient features of said mechanical control system include the feature of causing actions to be performed on specific vessels at specific times.

6. The apparatus as defined in claim 1, wherein said real-time features of said mechanical control system include the feature of satisfying the requirement that certain actions of one or more units of said apparatus must occur at a specific time in order for said apparatus to function correctly.

7. An apparatus for mechanical control of an automated immunochemistry or chemistry instrument which has a multiplicity of subsystems for performing immunochemistry or chemistry assays, the control apparatus comprising a mechanical control system having both object-orient features and real-time features for control of the operations of the multiplicity of subsystems.

8. The apparatus as defined in claim 7, wherein said mechanical control system comprises a sequencer for starting said operations of said multiplicity of subsystems at correct times respectively.

9. The apparatus as defined in claim 7, wherein said mechanical control system comprises a scheduler for determining the times when one or more sets of operations of said multiplicity of subsystems must be executed.

10. The apparatus as defined in claim 7, wherein said mechanical control system comprises a recipe containing instructions for each test.

11. The apparatus as defined in claim 7, wherein said mechanical control system comprises a chronicle which stores test history information pertaining to each test run.

12. The apparatus as defined in claim 7, wherein said object-orient features of said mechanical control system include the feature of hiding the real-time features in the subsystem base class.

13. The apparatus as defined in claim 7, wherein said object-orient features of said mechanical control system include the feature of causing actions to be performed on specific vessels at specific times.

14. The apparatus as defined in claim 7, wherein said real-time features of said mechanical control system include the feature of satisfying the requirement that certain actions of one or more units of said apparatus must occur at a specific time in order for said apparatus to function correctly.

15. A method for automated immunochemistry or chemistry analysis, comprising the steps of:
a. performing a multiplicity of steps for immunochemistry or chemistry assays, including the steps of:
(i) loading samples;
(ii) aliquoting samples;
(iii) storing sample aliquots;
(iv) supplying empty vessels used for containing sample aliquots and reagents;
(v) pipetting sample aliquots and reagents;
(vi) storing reagents;
(vii) incubating vessels containing samples and reagents;
(viii) transporting sample and reagent vessels; and
b. controlling said multiplicity of steps for immunochemistry or chemistry assays with a combination of both object-orient features and real-time features.

16. The method as defined in claim 15, wherein said controlling step further comprises a sequencing step for starting said multiplicity of steps for immunochemistry or chemistry assays at correct times respectively.

17. The apparatus as defined in claim 15, wherein said controlling step further comprises a scheduling step for determining the times when one or more sets of said multiplicity of steps for immunochemistry or chemistry assays must be executed.

18. The method as defined in claim 15, wherein said object-orient features of said controlling step include the feature of hiding the real-time features.

19. The method as defined in claim 15, wherein said object-orient features of said controlling step include the feature of causing actions to be performed on specific vessels at specific times.

20. The method as defined in claim 15, wherein said real-time features of said controlling step include the feature of satisfying the requirement that certain actions for said assay must occur at a specific time in order for said analysis to be performed correctly.

21. A method for controlling an automated immunochemistry or chemistry analysis process which includes a multiplicity of steps for immunochemistry or chemistry assays, the control method comprising the step of controlling said multiplicity of steps for immunochemistry or chemistry assays with a combination of both object-orient features and real-time features.

22. The method as defined in claim 21, wherein said controlling step further comprises a sequencing step for starting said multiplicity of steps for immunochemistry or chemistry assays at correct times respectively.

23. The method as defined in claim 21, wherein said controlling step further comprises a scheduling step for determining the times when one or more sets of said multiplicity of steps for immunochemistry or chemistry assays must be executed.

24. The method as defined in claim 21, wherein said object-orient features of said controlling step include the feature of hiding the real-time features.

25. The method as defined in claim 21, wherein said object-orient features of said controlling step include the feature of causing actions to be performed on specific vessels at specific times.

26. The method as defined in claim 21, wherein said real-time features of said controlling step include the feature of satisfying the requirement that certain actions for said assay must occur at a specific time in order for said analysis to be performed correctly.
